(19) United States
(12) Patent Application Publication
(10) Pub. No.: US 2012/0044508 A1
(43) Pub. Date: Feb. 23, 2012

(54) E-book device, method and computer-readable medium printing contents thereof

(75) Inventors: In-cheon Park, Hwaseong-si (KR); Jun-seung Lee, Seongnam-si (KR)

(73) Assignee: Samsung Electronics Co., Ltd., Suwon-si (KR)

(21) Appl. No.: 13/064,900

(22) Filed: Apr. 25, 2011

(30) Foreign Application Priority Data
Aug. 23, 2010 (KR) 10-2010-0081488

(51) Int. Cl. G06K 15/02

(52) U.S. Cl. 358/1.6

(57) ABSTRACT

A content printing method in an e-book device includes displaying an e-book, selecting a region on a screen displaying the e-book, storing contents corresponding to the selected region, forming data by combining pre-stored contents, sending the data to a printing device and printing the data when a printing request is input

### CROSS-REFERENCE TO RELATED APPLICATIONS

This application claims the benefit under 35 U.S.C. §119 (a) from Korean Patent Application No. 10-2010-0081488 filed on Aug. 23, 2010 in the Korean Intellectual Property Office, the entire disclosure of which is incorporated herein by reference.

### BACKGROUND

1. Field

The present disclosure relates generally to an e-book device, a method and computer-readable medium printing contents thereof. More particularly, the present disclosure relates to an e-book device selecting a region in an e-book and printing corresponding contents in the selected region, and a method of printing the contents in the e-book device.

2. Description of the Related Art

Thanks to an advance in electronic technology, a variety of electronic devices have been developed and released. Recently, as display panels have become smaller and higher in quality, small portable terminals such as PDA, mobile phone, and smart phone are drawing much attention.

Examples of such a portable terminal may include an e-book device. The e-book device is a portable device capable of displaying contents such as an e-book on a screen allowing a user to read many contents with ease. Lately, various e-book devices are under development, and the variety and the number of the e-book contents is notably increasing.

However, conventional e-book devices are limited to downloading contents from an external server and displaying the downloaded contents.

The user cannot print a selected portion of an e-book, or send the selected portion to other person.

In this regard, what is needed is a method allowing the user of the e-book device to fully utilize the contents of an e-book.

### SUMMARY

The present disclosure has been provided to address the above-mentioned and other problems and disadvantages, and an aspect of the present disclosure provides an e-book device for selectively printing contents, and a method of printing the contents of the e-book device.

The foregoing and/or other aspects are achieved by providing a method of printing contents in an e-book device including displaying an e-book, selecting a region on a screen displaying the e-book, storing contents corresponding to the selected region forming data by combining pre-stored contents when a printing request is input and sending the data to a printing device and printing the data.

The method may further include displaying a UI (User Interface) comprising a first menu item for immediately printing the contents corresponding to the selected region and a second menu item for storing the contents when the region is selected, sending the contents to the printing device and immediately printing the contents when the first menu is selected, and storing the contents when the second menu item is selected.

The method may further include inputting a user memorandum. The immediate printing of the contents may send data with the user memorandum attached to the contents of the selected region, to the printing device and the user memorandum and the contents may be printed together.

The method may further include inputting a user memorandum and attaching the user memorandum to the contents corresponding to the selected region. The printing may send to the printing device and print data combining the contents with the user memorandum attached.

The printing may send to the printing device and print at least one additional information of a user memorandum written for the selected region including a selection date of the region, location information of the selected region in the e-book, and an e-book title, together with the contents.

The storing of the contents may including storing additional information of the contents together with the contents.

The forming of the data may include combining the pre-stored contents to a standard format data printable by the printing device, and the printing may send the data to the printing device over a wireless network.

The foregoing and/or other aspects are achieved by providing an e-book device including a user interface unit displaying an e-book and selecting a region in the displayed e-book, a storage unit storing contents, a communication unit communicating with a printing device and a controller storing contents corresponding to the selected region to the storage unit, and, when a printing request is input, sending data combining contents pre-stored in the storage unit to the printing device through the communication unit to print the contents.

When a region is selected on the screen, the user interface unit may display a UI (User Interface) which includes a first menu item for immediately printing the contents corresponding to the selected region and a second menu item for storing the contents. When the first menu item is selected, the controller may send the contents to the printing device to immediately print the contents, and when the second menu item is selected, the controller may store the contents in the storage unit.

When the second menu item is selected, the controller may store additional information of the contents together with the contents, and the additional information may include at least one of a user memorandum written for the selected region, a selection date of the region, location information of the selected region in the e-book, and an e-book title.

The display unit may display a UI (User Interface) for inputting information relating to the printing device to print the data, and the communication unit may communicate with a printing device corresponding to the information input.

The controller may automatically search printing devices connectable by the communication unit, generate a list of available printing devices, display the list by the user interface unit, and send the data to a selected printing device when at least one printing device is selected in the list.

The user interface unit may receive a user memorandum for the selected region, and the controller may send data with the user memorandum attached to the contents corresponding to the selected region to the printing device to print the data.

The controller may form data of a standard format printable by the printing device by combining the pre-stored contents and send the data to the printing device over a wireless network.

The foregoing and/or other aspects are achieved by providing a method of printing contents in an e-book device including installing an application providing a content print function to the e-book device, displaying an e-book on the e-book device, selecting a region on a screen displaying the e-book and sending to the printing device and printing contents corresponding to the selected region by executing the application.

The method may further include inputting a user memorandum in the selected region. The printing may overlap the user memorandum with the contents using the application, and send the user memorandum and the contents to the printing device to print the user memorandum and the contents.

The method may further include when a region of the screen is selected, storing contents corresponding to the selected region. When a print command for printing the selected contents is input, the printing may send printing data combining the stored contents using the application to the printing device to print the data.

The printing device may include at least one of a default printing device set by the e-book device, a printing device manually set by the e-book device and a printing device searched for and discovered by the e-book device.

The foregoing and/or other aspects are achieved by providing at least one non-transitory computer readable medium comprising computer readable instructions that control at least one processor to implement a content printing method of a portable terminal device. The content printing method includes displaying contents, selecting a region on a screen which displays the contents, storing data corresponding to the selected region, forming data by combining pre-stored contents, sending the data to a printing device and printing the data when a printing request is input.

The content printing method may further include inputting a user memorandum and attaching the user memorandum to the contents corresponding to the selected region. The printing may send data combining the contents corresponding to the selected region with the user memorandum attached to the printing device to print the data.

The foregoing and/or other aspects are achieved by providing at least one non-transitory computer readable medium including computer readable instructions that control at least one processor to implement methods of one or more embodiments.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram of an e-book device and a printing device according to example embodiments;

FIG. 2 is a block diagram of the e-book device according to example embodiments;

FIG. 3 is a diagram of a method of selecting a certain region of an e-book in the e-book device;

FIG. 4 is a diagram of a menu selection method of determining an operation after contents are selected;

FIG. 5 is a diagram of a method of manually searching for a printing device to print the contents;

FIG. 6 is a diagram of a method of automatically searching for a printing device to print the contents;

FIG. 7 is a diagram of a UI for determining printing attributes for the contents;

FIG. 8 is a diagram of data formed with the contents of the region selected by a user;

FIG. 9 is a diagram of a printing document printed by combining a plurality of contents selected;

FIG. 10 is a diagram of data formed by extracting the contents of the region selected by the user;

FIG. 11 is a diagram of a method of storing the contents of the region selected by the user;

FIG. 12 is a flowchart of a content printing method according to example embodiments;

FIG. 13 is a flowchart of a content printing method according to example embodiments;

FIG. 14 is a flowchart of a content printing method according to example embodiments; and

FIG. 15 is a flowchart of the content printing method including installing an application program to the e-book device.

### DETAILED DESCRIPTION

Reference will now be made in detail to embodiments, examples of which are illustrated in the accompanying drawings, wherein like reference numerals refer to like elements throughout. Embodiments are described below in order to explain the present disclosure by referring to the drawings.

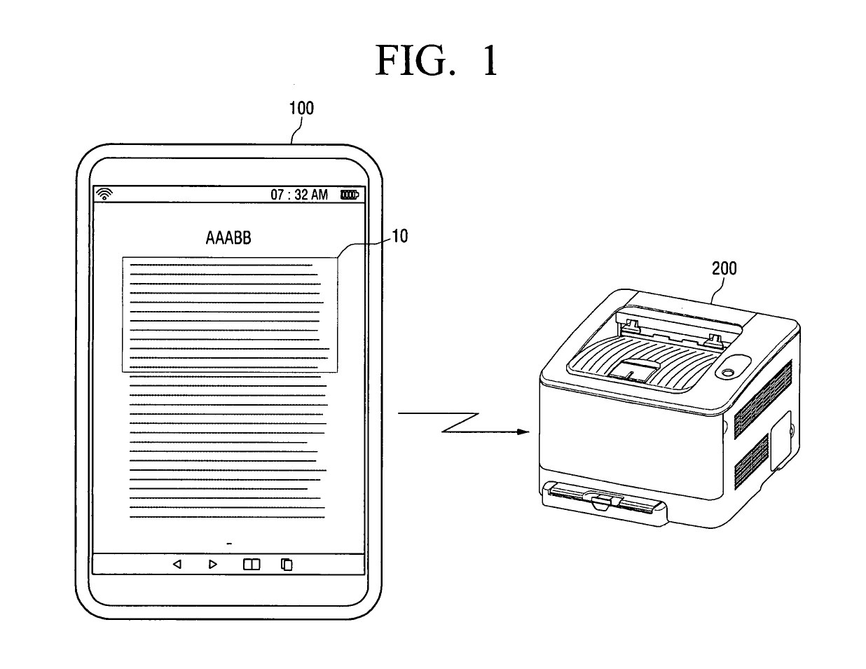

FIG. 1 is a diagram of an e-book device and a printing device according to example embodiments.

Referring to FIG. 1, the e-book device 100 may display an e-book on its screen. In general, the e-book may content contents written in DTbook or XHTML format. The e-book device 100 may display text or image of various displayable formats as well as e-books. The e-book device 100 shown in FIG. 1 is merely an example, and may also be implemented according to various electronic devices having an e-book function or various portable devices having a display function.

When a user who is reading an e-book using the e-book device 100, finds a particular portion or region of the e-book that piques the user's interest or which the user wishes to save, the user may select the particular portion. If the e-book device 100 includes a touch screen, the region may be selected by touching the screen, or also may be selected using keys or a cursor.

When the user selects the region, the selected region may go through various processes.

For example, when the user selects a region, contents corresponding to the selected region may be detected and transferred to the printing device 200. The printing device 200 may print the corresponding contents immediately. The contents may be detected and transmitted at a same time when the region selection is completed, or when a separate request command is input.

Meanwhile, the user may add a user memorandum or note to the selected region. The contents with the user memo attached may be transferred to and printed by the printing device 200.

Alternatively, the user may store the contents of the selected region and then print and check all of the stored contents at a later time. More specifically, if the user reads a plurality of pages or books and wants to extract and print only parts including contents to remember, the user may frequently select the corresponding region every time the user finds a particular portion or region of the e-book that piques the user's interest or which the user wishes to save. The contents of the selected region may be stored to a storage unit.

Next, when the user inputs a printing request, the pre-stored contents may be combined and printed into the same document. In more detail, the user may select a stored data output menu using menus of the e-book device 100. When the stored data output menu is selected, the e-book device 100 may display a list of the pre-stored contents. Thus, the list may be arranged by e-book. Using the list, the user may select one or more contents to print, and edit to delete or transfer the contents.

When the user selects the contents to print, the e-book device 100 may form data combining the selected contents, sends the formed data to the printing device 200, and perform the printing job. As a result, when the contents are selected in the list, before the contents are transferred to the printing device 200 a preview screen or a layout adjust screen including the selected contents may be provided. Hence, when the user adjusts the layout or requests to print the current data, the layout may be adjusted as requested or the data may be sent to the printing device 200.

Thus, when the user selects and prints the stored contents, additional information such as the user memo or note may be attached to the content.

The immediate printing or storing of the contents may be performed according to an option preset by the user. When the user sets the selected region immediate print option in advance, the immediate printing may be carried out every time the region is selected. Alternatively, when the user presets the selected region store option, the selected region may be stored right away every time the region is selected.

Without presetting the printing option as above, the menus may be provided in every region selection to allow the user to select the operation.

As a result, the contents may be utilized in various ways.

Meanwhile, the e-book device 100 may be operated by executing an application program installed to the e-book device 100. When the e-book device 100 is released, the application program may be installed to the e-book device 100 as a basic application program. Alternatively, the user of the e-book device 100 may download the application program from a separate application provider, for example, from an application store and install the downloaded application program to the e-book device 100.

Accordingly, when the e-book is displayed or when a part of the e-book contents is selected, the application may be executed to conduct various operations.

The e-book device 100 may communicate with the printing device 200 to send the data including the contents. The connection to the printing device 200 may use a general wired interface such as a USB interface or local interface, or use a wireless network such as WiFi. The e-book device 100 may download the contents using a wireless network technology such as WiFi or Bluetooth, without utilizing a wired interface port. The e-book device 100 may be connected with the printing device 200 to transfer the contents using a communication interface of a conventional e-book device 100, without having to add separate hardware.

In FIG. 1, the printing device 200 may be set manually or automatically in the e-book device 100. The printing device 200 of FIG. 1 may be a standard platform printer capable of receiving and printing data from the e-book device 100 over a network such as the Internet.

More specifically, the e-book device 100 may send the data to the printing device 200 to print the data using a print service including Universal Plug and Play (UPnP), or Internet Printing Protocol (IPP). To process the data, the printing device 200 may be implemented using an IPP printer or a UPnP printer.

UPnP is a standard allowing various devices accessing a network to automatically discover each other using Internet and web protocols. Using UPnP, even if a printer driver and a port are not set, the e-book device 100 and the printing device 200 may discover each other to communicate data. In more detail, the e-book device 100 may search for the available printing devices 200 in the network by sending a discovery request signal over the network. Thus, the printing device 200 receiving the corresponding signal may respond with its location in a URL format, and uploading of the data can be performed.

The e-book device 100 may print the contents in a network output scheme using a 9100 port.

The printing device 200 of FIG. 1 may be implemented using various printers such as an inkjet printer or a laser printer. In detail, the printing device 200 may be various image forming devices such as printers, copiers, and multi-function devices. The laser-type printing device 200 may include an engine unit including a charger, a laser scanning unit, a developer, a transferrer, a fuser, and a video controller unit. The video controller unit of the printing device 200 may convert the data received from the e-book device 100 to a bitmap image output in the format, and provide the converted bitmap image to the engine unit. The engine unit may print the corresponding data onto paper.

The printing device 200 of FIG. 1 may be a general printing device. Hence, the operations and the structure of the printing device shall be omitted here.

According to example embodiments, it is possible to process the contents of the e-book device in the e-book device immediately without using a PC or other equipment, and to print the contents. As a result, the e-book may be printed directly from the e-book device, and the printing of an unauthorized e-book may be forbidden.

Attribute information of e-book contents may include a field for setting the printing. If an e-book is authorized to print, a user may select and print a particular region using the e-book device.

By contrast, if an e-book is not authorized to print, region selection and storing may be allowed but printing may be prohibited. In this case, the user may select regions by providing input to the e-book device 100.

The ability to print may be determined by an e-book seller or provider. An e-book authorized to print may be sold at a higher price than an e-book unauthorized to print.

Alternatively, printing may be limited between the e-book device and the printing device. In other words, when the manufacturer or the e-book device is the same as the manufacturer of the printing device, the output format of the e-book device may be specified and a video controller unit of the printing device may process data having a specific output format. Hence, the selective printing function may be executed only for the printing device of a particular company and thus it is possible to promote the printing device together with the e-book device.

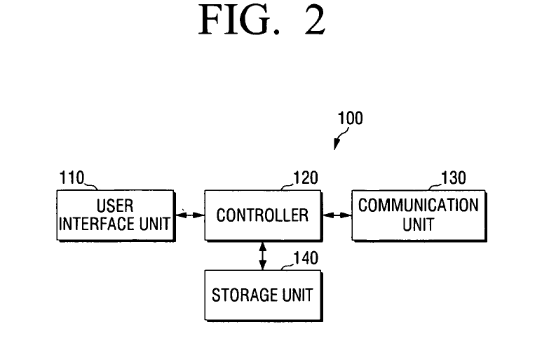

FIG. 2 is a block diagram of the e-book device according to example embodiments. Referring to FIG. 2, the e-book device 100 may include a user interface unit 110, a controller 120, a communication unit 130, and a storage unit 140.

The user interface unit 110 may display the e-book and receive a user's input. The user interface unit 110 may include a touch screen. Alternatively, the user interface 110 may include an output unit (for example, a display panel) and an input unit (for example, a key button) separately.

The controller 120 may control the operations of the e-book device 100.

The storage unit 140 may store e-book data displayed on the e-book device 100, application programs, user setting data, an Operating System (O/S), etc. The storage unit 140 is a computer-readable storage unit and may include, but is not limited to, one or more of a RAM, a ROM, a flash memory, a memory card, and a HDD, and other various storage means. While a single storage unit 140 is depicted in FIG. 2, there may be more than one computer-readable storage unit included as part of storage unit 140.

The communication unit 130 may be connected with an external device to allow communication. The communication unit 130 may be connected to an external server (not shown) to download various contents and applications. The communication unit 130 may be connected to the printing device 200 to send the contents as shown in FIG. 1.

When the user interface 110 displays the contents and a particular region is selected, the controller 120 may detect the contents of the selected region.

According to the format of the contents, the controller 120 may extract the data which may be text or an image. For example, when the contents are in an e-book content format XHTML or in the format EPUB or PDF, the controller 120 may extract the text in the selected region. When the contents are the image, the controller 120 may convert and detect the image as the contents.

The controller 120 may immediately print or store the contents of the selected region. The operations of the controller 120 may vary according to example embodiments.

According to example embodiments, when the region is selected, the controller 120 may immediately form the contents of the selected region as data of in an available format and transfer the data to the printing device, without a user's separate request. As a result, the printing may be conducted in real time.

According to example embodiments, when the region is selected, the controller 120 may provide the user menu with menu options for printing the data immediately or storing the data through the user interface unit 110, and immediately printing or storing the data according to the selected menu option.

According to example embodiments, the controller 120 may immediately print or store the contents according to a preset option. In other words, the user may set preset whether to print immediately or to store and print later. The controller 120 may perform the printing or saving corresponding to this preset setting.

According to example embodiments, every time a region is selected, the controller 120 may store the contents of the selected region to the storage unit 140 immediately.

As a result, the controller 120 may print or store the contents in various different ways.

When a printing request for pre-selected and stored contents is input, the controller 120 may form data by combining the contents pre-stored to the storage unit 140 and then transfer the formed data to the printing device 200 via the communication unit 130. As a result, the printing device 200 may print the data.

As described above, when the user memo or note is attached, the controller 120 may print or store the contents by attaching the user memo to the contents. The user memo may be attached by being overlapping with the contents.

The controller 120 may generate a UI (User Interface) for selecting the region selection unit and arranging and selecting the list for the pre-stored contents, and display the UI through the user interface 110.

The controller 120 may be operated by executing an application program installed onto the e-book device 100. In other words, the controller 120 may include a CPU and a RAM. By executing the application program using the RAM, the CPU may perform various tasks, for example, select contents of a selected region, print or store the selected region, combine pre-stored contents, communicate with the printing device, send data to the printing device, send a print command, and attach additional information such as the user memo or notes.

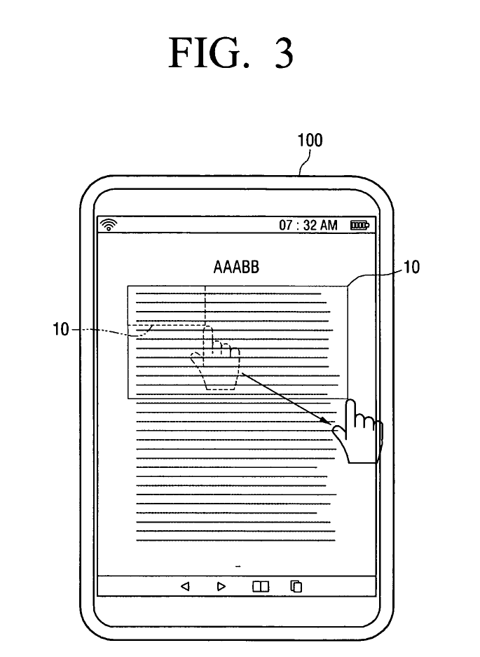

FIG. 3 is a diagram of a region selection method according to example embodiments. The user interface unit 110 may be activated by interacting with a touch screen and the user may select the region with a hand or a touch pen.

As shown in FIG. 3, the screen may displays a title “AAABB” and contents of the e-book, and the user may select a region 10 in the screen by touching and dragging the particular selection region 10. The selection region 10 may be marked in a quadrangle, and its size may be adjusted according to movement of the user's touch point. In other words, the user may determine the selection region by moving in a diagonal direction while touching a spot and then finishing the touch.

Unlike as shown in FIG. 3, the user may also select the region using an input means such as a key or button provided on the e-book device 100. In this case, a selection key may be selected first. In other words, a user can determine whether the region should include a particular page, paragraph, sentence or word. The user may make their selection of a particular region by using up/down and/or left/right keys. More specifically, when the user manipulates these keys while pressing the selection key at a region selection start point, the selection region may expand from the start point outward. When the user releases the selection key, the selection region may be finalized.

In the region selection as stated above, the selected region may be specified with a bold solid-line box or a dotted-line box. Alternatively, the selected region may be shaded or represented in a different color from the other regions so that the user may easily perceive the selected region.

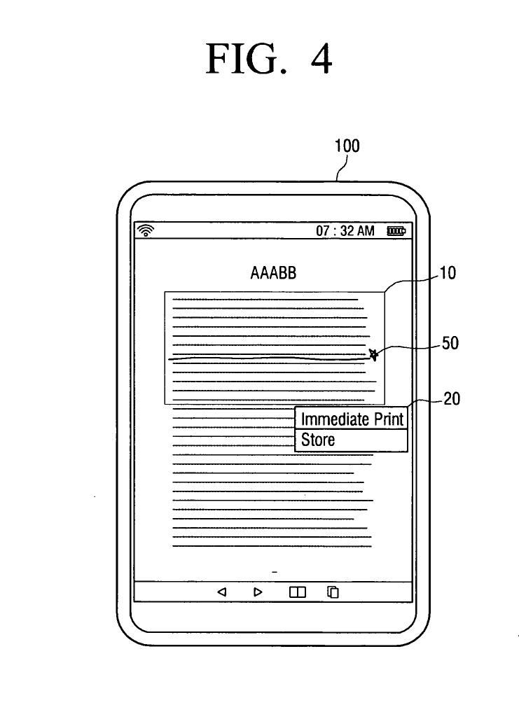

FIG. 4 depicts a screen after the region is selected. When the user selects a region of the e-book, a user menu 20 may be displayed on a side of the selected region. While an immediate print menu option and a store menu option are displayed in FIG. 4, the user menu 20 may include other various menu options.

When the immediate print menu is selected in FIG. 4, the e-book device 100 may detect and send contents of the selected region to the printing device 200. With the e-book device 100 as shown in FIG. 2, the communication unit 130 may be connected with the printing device 200 over the wireless network and the controller 120 may send the data including the detected contents to the printing device 200 to print the data. The controller 120 may form and transfer the contents according to the data format of the open standard recognizable by the printing device 200.

When the user selects the store menu, the contents corresponding to the selected region may be stored to the storage unit 140. Thus, when the user memo 50 is written as shown in FIG. 4, the user memo 50 may be stored together with the contents.

Additional information may also be stored with the contents. The additional information may include a date of the corresponding region selection, location information (i.e., page, paragraph, or line information) of the selected region in the e-book, and the e-book title, as well as the user memo written in the selected region.

The user may write the user memo 50 in the selected region as shown in FIG. 4. As an example, a user may draw and underline and star 50. However, the user memo 50 may be input as text. A separate window for inputting the user memo 50 may be provided so that the user may write the user memo, without directly writing the memo on the screen. Thus, the user memo 50 may be recorded by allowing the user to directly write on the touch screen, or through the input using a software-based keyboard or character keys.

Next, when the printing request is input, the stored data may be combined with the pre-stored data and output as one document. After reading several books, the user may have stored several regions. The additional information may printed together with the regions

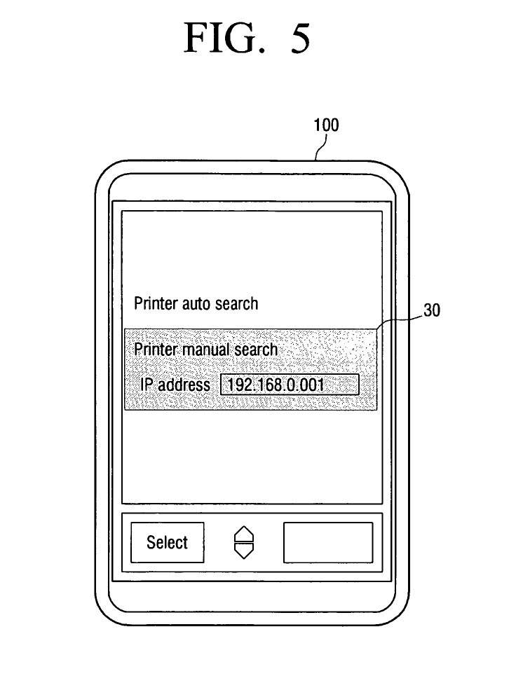

FIG. 5 depicts a UI (User Interface) for manually setting the printing device to print the contents. As shown in FIG. 5, the screen of the e-book device 100 may display the UI 30 allowing inputting information of the printer. While an IP address is shown in FIG. 5, a URL of a network printer may also be input. The printing device also may be set manually by inputting information such as a printer name and a manufacturer name.

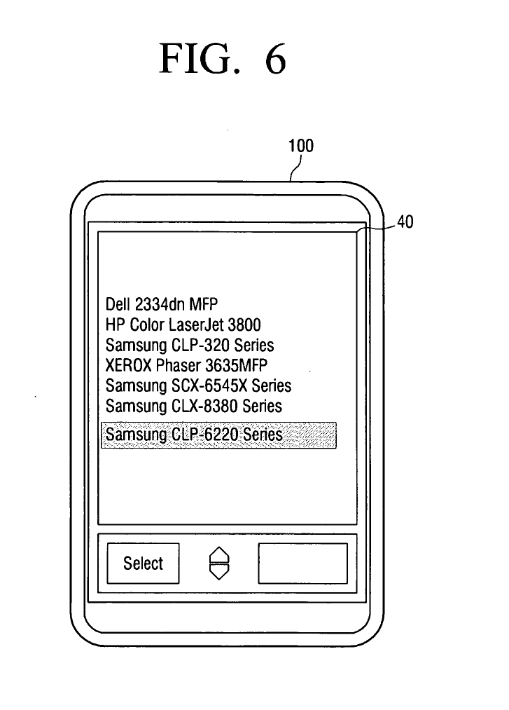

FIG. 6 depicts a UI for automatically setting the printing device to print the contents. The e-book device 100 may display the UI 40 having available printing devices shown in a list by searching every available printing device in FIG. 6. The printing devices may be searched using Bonjour, Simple Service Discovery Protocol (SSDP) of UPnP, and WS-Discovery. The user may select the printing device to use in the list by using the direction keys and cursor, or by touching their selection displayed on screen.

If there is a default printing device, the default printing device may be used, without manually or automatically setting the printing device as shown in FIGS. 5 and 6.

The printing device receiving the data from the e-book device 100 may print the received data. If the e-book device 100 sends the data in the data format of the open standard as mentioned above, the printing device may perform the printing job of the received data.

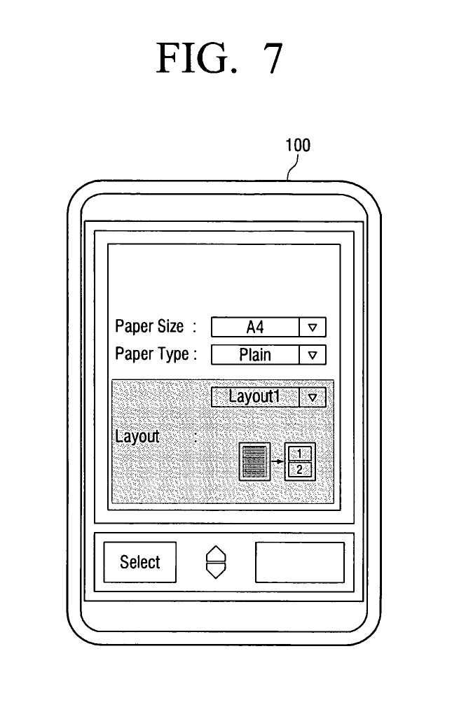

FIG. 7 depicts a UI for setting printing options in the e-book device 100. Various options for setting a paper size, a paper type, and a layout may be provided on the screen as shown in FIG. 7. Information regarding the set printing options may be sent to the printing device 200 to apply to the printing job.

The printing device and the printing options shown in FIGS. 5, 6 and 7 may be set every time the contents are selected or the print command is input. According to example embodiments, when the user completes the region selection, selects the immediate print menu, or inputs the printing request for the pre-stored contents, at least one UI as shown in FIGS. 5, 6 and 7 may be provided.

Alternatively, the printing device and the printing options may be set prior to the content selection. The user may preset the printing device or the printing options by selecting a user option of the e-book device 100. When the region is selected in the e-book or the printing request is input, the contents may be printed by immediately accessing the preset printing device.

Referring back to FIG. 2, when the region is selected, the controller 120 may form the data by converting the contents corresponding to the selected region into the output format. While the controller 120 may form the data using a printer language such as PCL or PS, a simple layout may be formed using XHTML-print. In particular, a plurality of contents may be included in one data.

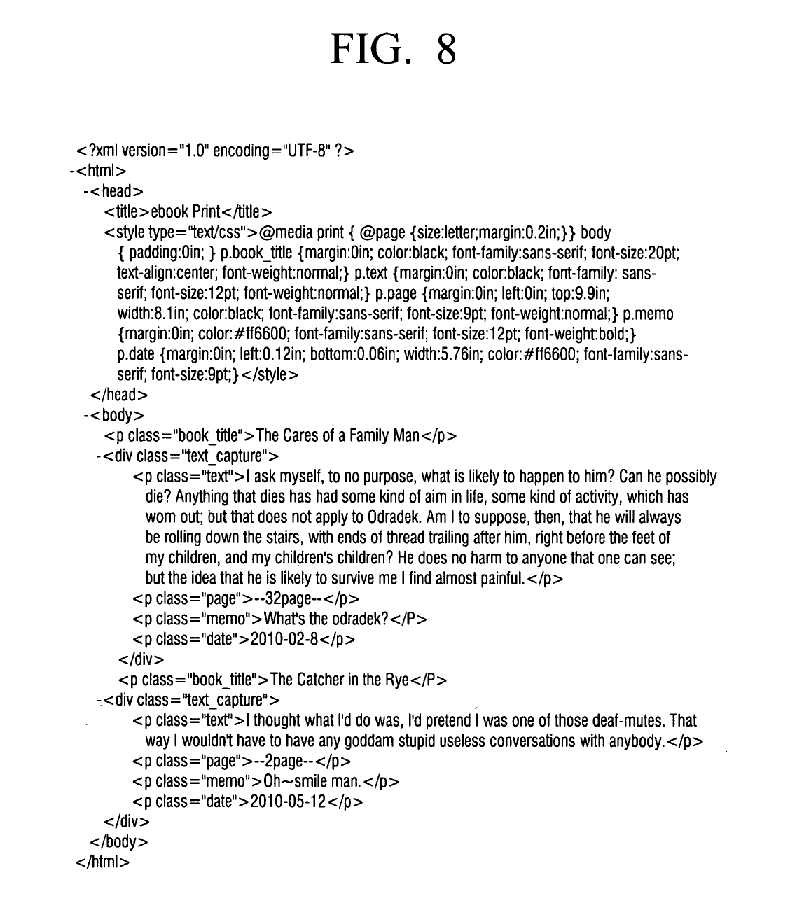

FIG. 8 depicts example data in XHTML-print.

The data may include a head part defining a title of the e-book including the selected region and a style type, and a body part including actual type information, detected text contents, page information, selection date, and user memo. The style type may define various style attributes such as font size and color.

Referring to FIG. 8, the body part shows that two contents may be combined.

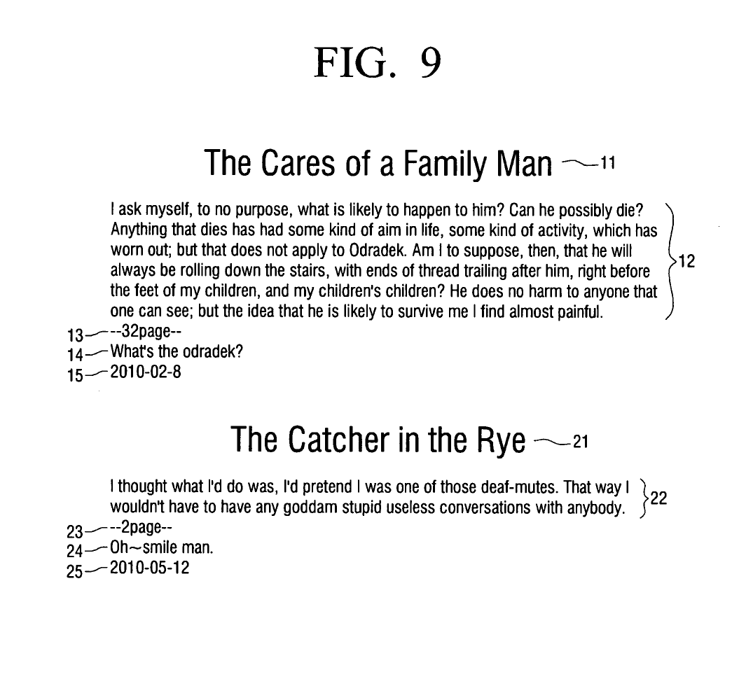

FIG. 9 shows an example of a printed version of the data shown in FIG. 8. FIG. 9 shows a title 11 of the e-book of a first content, contents 12, page information 13, a user memo 14, and a date 15 selected or stored. FIG. 9 also shows a title 21 of the e-book of a second content, contents 22, page information 23, a user memo 24, and a date 25 selected or stored. Thus, the user may select regions from various e-books and then print these regions as one document. While the user memos 14 and 24 may be separately printed under the contents as shown in FIG. 9, the user memo may also overlap with the contents as shown in FIG. 4. In addition, the document may be printed to a PDF, rather than the data format shown in FIG. 8.

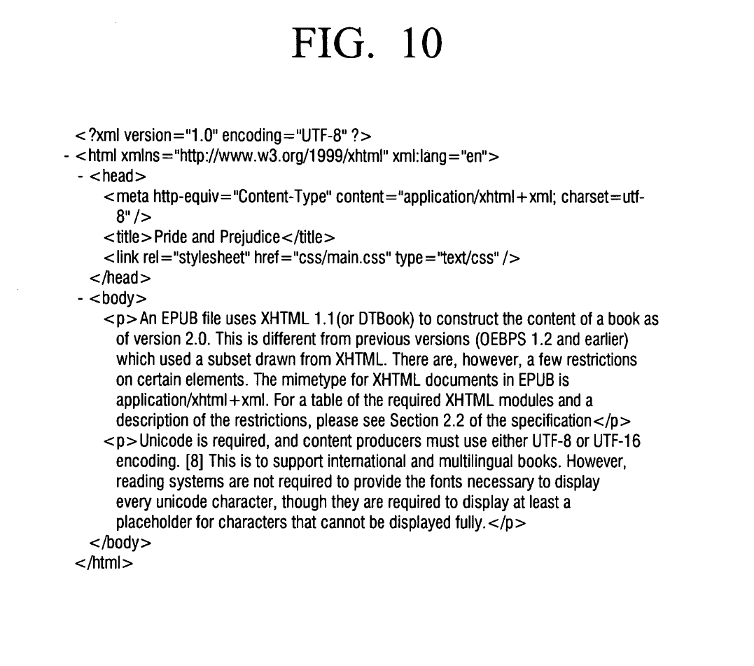

FIG. 10 depicts data having one contents. The head part may include a title “Pride and Prejudice”, metadata, and attributes, and the body part may include contents.

Thus, the controller 120 may form the data in various formats, and store or send the data to the printing device.

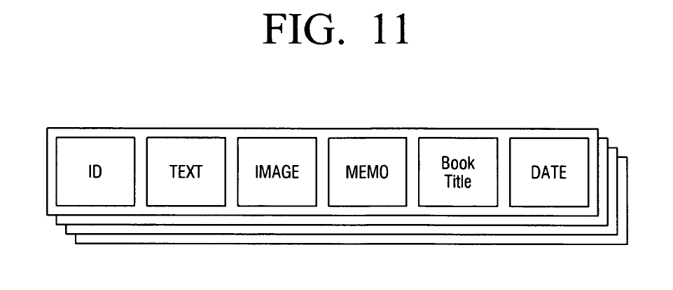

FIG. 11 depicts data stored to the storage unit 140. The storage unit 140 may store at least one of a TEXT and an IMAGE which may be the contents corresponding to the selected region, together with additional information such as ID, user memo, e-book title, and date selected or stored. ID may indicate information assigned to identify the corresponding contents. The data of FIG. 11 may be recorded as a single file.

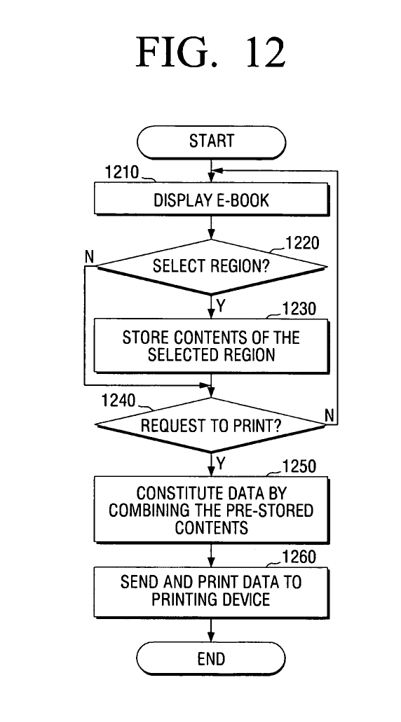

FIG. 12 is a flowchart of a content printing method according to example embodiments. When the e-book is displayed (1210) and a region is selected (1220), contents of the selected region may be stored immediately (1230).

After storing the contents, the user may continue to read the e-book. At this time, when the user inputs the printing request (1240), the e-book device may form data by combining all of the pre-stored contents (1250). The data may be formed by combining all of the pre-stored contents, or by combining only contents selected by the user after a content list is provided to the user. The content list may be arranged by e-book title. When the user selects an e-book title, the regions selected in the corresponding e-book may be combined.

When the data is formed, the e-book device may send the data to the printing device to be printed (1260). The printing device may be selected via input of IP information manually input by the user, or by using automatic search of a printing device. Alternatively, when there is the default printing device, the default printing device may be selected.

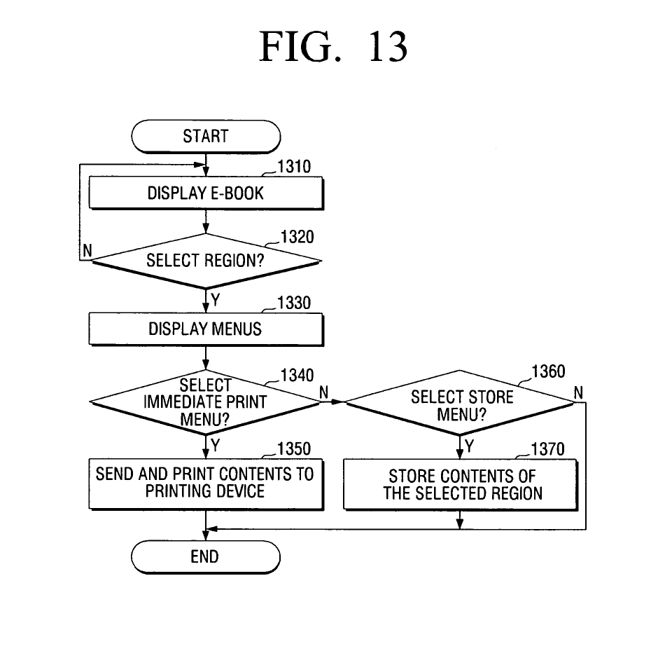

FIG. 13 is a flowchart of a content printing method according to example embodiments.

When the e-book is displayed (1310) and a region is selected (1320), selectable menus may be displayed (1330). The menus may be displayed on one side of the selected region as a pop-up window as shown in FIG. 4, or in a separate area.

When the immediate print menu is selected (1340), the e-book device may convert the contents of the current selected region into an output data format and send the converted contents to the printing device to print the contents (1350).

When the store menu is selected (1360), the e-book device may detect and store the contents, i.e., the text or the image of the selected region (1370). The additional information such as selection date, e-book title, location of the corresponding contents (i.e., page, paragraph, line information) and user memo may be stored together.

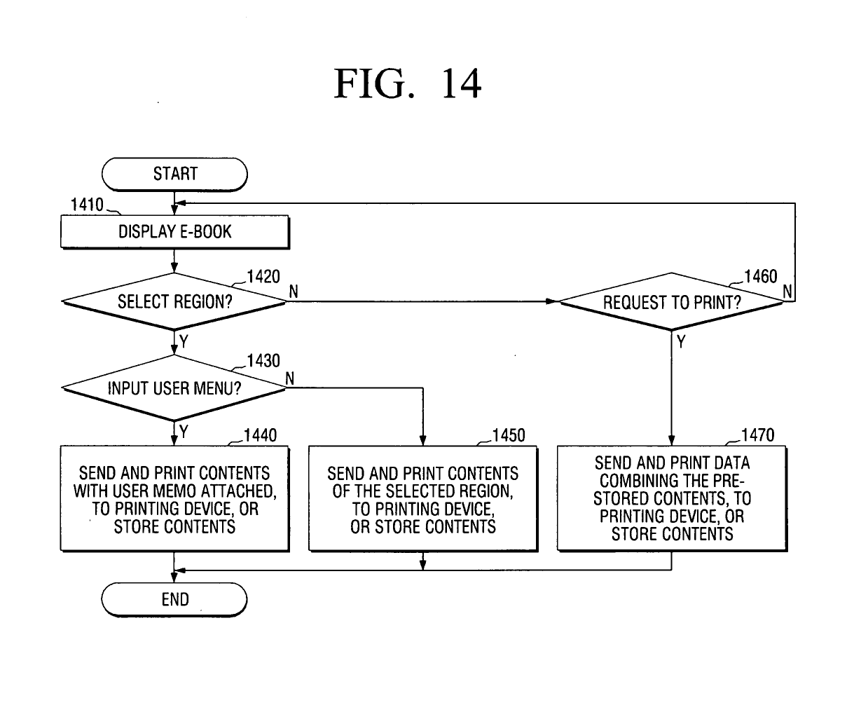

FIG. 14 is a flowchart of a content printing method according to example embodiments.

When the e-book is displayed (1410), a region may be selected (1420), and a user memo may be input (1430). The e-book device may send the contents with the user memo attached to the printing device to print the contents, or store the contents to a storage unit (1440). The user memo may overlap with content as shown in FIG. 4, or be separately attached to the contents as the text as shown in FIG. 9. It may be determined by the user whether the contents will be printed or stored based on a user menu selection or a preset option.

If the user memo is not input, the e-book device may send and send the contents of the selected region to the printing device, or store the contents (1450).

When the region is not selected but the printing request is input (1460), the e-book device may combine the pre-stored contents and send the data to the printing device to be printed (1470). All of the pre-stored contents may be combined, only contents selected by the user may be combined, or only contents corresponding to an item selected by the user may be combined. More specifically, the user may select an e-book, or an item such as date selected or stored, author, and publisher. When the item is selected, the contents belonging to the selected item may be combined, transferred to the printing device, and then printed.

The operations of the e-book device may be carried out by executing the application program provided and installed on the e-book device.

The user of the e-book device may download the application program providing the content printing function by accessing a server providing an application store with the program.

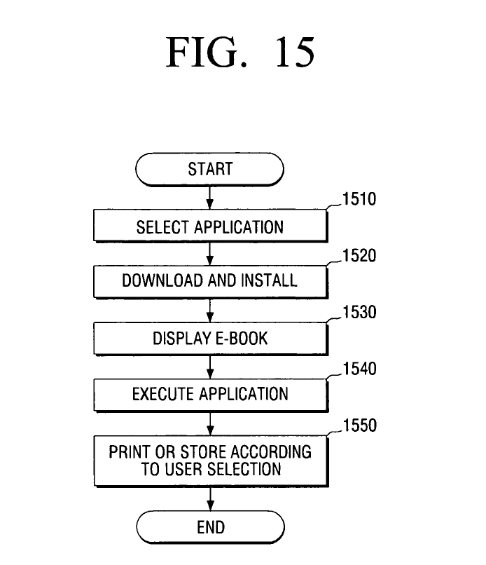

FIG. 15 is a simplified flowchart of a method of using the application in the e-book device.

By displaying a web page provided by the external server, the user may select a version of the application corresponding to his/her e-book device version and O/S (1510). The application may be free or have a price and may be provided by the server.

The selected application may be downloaded to the e-book device and installed to an internal memory (1520). The application may be executed in conjunction with the program which displays the e-book.

The user may display the e-book by inputting the select command (1530), and the corresponding application may be executed (1540).

When the particular region is selected as shown in FIGS. 12, 13 and 14, the application may print or store the selected region, or combine and print the pre-stored contents. When the user memo is input, the user memo may be attached to the contents and printed together.

While the application may be executed to print or store the contents after the region is selected, region selection may also be supported by the application. In other words, when the O/S or the applications installed onto the conventional e-book device does or do not provide a region selection function, the present application may provide the region selection function.

The above-described embodiments may be recorded in non-transitory computer-readable media including program instructions to implement various operations embodied by a computer. The media may also include, alone or in combination with the program instructions, data files, data structures, and the like. Examples of computer-readable media (computer-readable storage devices) include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may be a plurality of computer-readable storage devices in a distributed network, so that the program instructions are stored in the plurality of computer-readable storage devices and executed in a distributed fashion. The program instructions may be executed by one or more processors or processing devices. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

As set forth above, the contents may be utilized in various ways by the e-book device.

Although embodiments have been shown and described, it should be appreciated by those skilled in the art that changes may be made in these embodiments without departing from the principles and spirit of the disclosure, the scope of which is defined in the appended claims and their equivalents.

What is claimed is:

1. A method of printing contents using an e-book device, comprising:
displaying an e-book;
selecting a region on a screen displaying the e-book;
storing contents corresponding to the selected region;
forming data by combining pre-stored contents when a printing request is input; and
sending the data to a printing device and printing the data.

2. The method of claim 1, further comprising:
displaying a UI (User Interface) comprising a first menu item for immediately printing the contents corresponding to the selected region and a second menu item for storing the contents when the region is selected;
sending the contents to the printing device and immediately printing the contents when the first menu item is selected; and
storing the contents when the second menu item is selected.

3. The method of claim 2, further comprising:
inputting a user memorandum,
wherein the immediately printing of the contents sends data with the user memorandum attached to the contents of the selected region to the printing device and the user memorandum and contents are printed together.

4. The method of claim 1, further comprising:
inputting a user memorandum; and
attaching the user memorandum to the contents corresponding to the selected region,
wherein the printing sends to the printing device and prints data combining the contents with the user memorandum attached.

5. The method of claim 1, wherein the printing sends to the printing device and prints at least one additional information of a user memorandum written for the selected region including a selection date of the region, location information of the selected region in the e-book, and an e-book title together with the contents.

6. The method of claim 1, wherein the storing of the contents stores additional information of the contents together with the contents.

7. The method of claim 1, wherein the forming of the data combines the pre-stored contents to a standard format data printable by the printing device, and
the printing sends the data to the printing device over a wireless network.

8. An e-book device, comprising:
a user interface unit displaying an e-book and selecting a region in the displayed e-book;
a storage unit storing contents;
a communication unit communicating with a printing device; and
a controller storing contents corresponding to the selected region to the storage unit, and when a printing request is input, sending data combining contents pre-stored in the storage unit to the printing device through the communication unit to print the contents.

9. The e-book device of claim 8, wherein, when a region is selected, the user interface unit displays a UI (User Interface) which comprises a first menu item for immediately printing the contents corresponding to the selected region and a second menu item for storing the contents, and
when the first menu item is selected, the controller sends the contents to the printing device to immediately print the contents, and when the second menu item is selected, the controller stores the contents in the storage unit.

10. The e-book device of claim 9, wherein, when the second menu item is selected, the controller stores additional information of the contents together with the contents, and
the additional information comprises at least one of a user memorandum for the selected region, a selection date of the region, location information of the selected region in the e-book, and an e-book title.

11. The e-book device of claim 8, wherein a display unit displays a UI (User Interface) for inputting information relating to the printing device to print the data, and
the communication unit communicates with the printing device corresponding to the information input.

12. The e-book device of claim 8, wherein the controller automatically searches printing devices connectable by the communication unit, generates a list of available printing devices, displays the list by the user interface unit, and sends the data to a selected printing device when at least one printing device is selected in the list.

13. The e-book device of claim 8, wherein the user interface unit receives a user memorandum for the selected region, and
the controller sends data with the user memorandum attached to the contents corresponding to the selected region to the printing device to print the data.

14. The e-book device of claim 8, wherein the controller forms data of a standard format printable by the printing device by combining the pre-stored contents and sends the data to the printing device over a wireless network.

15. A method of printing contents in an e-book device, comprising:
installing an application providing a content print function to the e-book device;
displaying an e-book on the e-book device;
selecting a region on a screen displaying the e-book; and
sending to the printing device and printing contents corresponding to the selected region by executing the application.

16. The method of claim 15, further comprising:
inputting a user memorandum in the selected region,
wherein the printing overlaps the user memorandum with the contents using the application and sends the user memorandum and the contents to the printing device to print the user memorandum and the contents.

17. The method of claim 15, further comprising:
when a region of the screen is selected, storing contents corresponding to the selected region,
wherein when a print command for printing the selected contents is input, the printing sends printing data combining the stored contents using the application to the printing device to print the data.

18. The method of claim 15, wherein the printing device comprises at least one of a default printing device set by the e-book device, a printing device manually set by the e-book device, and a printing device searched for and discovered by the e-book device.

19. At least one non-transitory computer readable medium comprising computer readable instructions that control at least one processor to implement a content printing method of a portable terminal device, the content printing method comprising displaying contents, selecting a region on a screen that displays the contents, storing data corresponding to the selected region, forming data by combining pre-stored contents, sending the data to a printing device and printing the data when a printing request is input.

20. The at least one non-transitory computer readable medium of claim 19, wherein the content printing method further comprises:
inputting a user memorandum; and
attaching the user memorandum to the contents corresponding to the selected region, and
the printing sends data combining the contents corresponding to the selected, region with the user memorandum attached to the printing device to print the data.
